(19) United States
(12) Patent Application Publication
(10) Pub. No.: US 2007/0174680 A1
(43) Pub. Date: Jul. 26, 2007

(54) Method for patching built-in code in read only memory

(75) Inventors: Chao-Ping Su, Hsinchu City (TW); Ching-Han Hsiao, Zhubei City (TW)

Correspondence Address: BRUCE H. TROXELL, SUITE 1404, 5205 LEESBURG PIKE, FALLS CHURCH, VA, 22041, US

(73) Assignee: MSTAR SEMICONDUCTOR, INC.

(21) Appl. No.: 11/414,331

(22) Filed: May 1, 2006

(30) Foreign Application Priority Data
Nov. 8, 2005 (TW) 094139180

(51) Int. Cl. G06F 11/00

(52) U.S. Cl. 714/8

(57) ABSTRACT

The invention discloses a patching method to correct the built-in code in read only memory (ROM), which loads the patching address stored in an external storage device and the patching content into a register and a RAM respectively. When the executing sequence reaches the patching address in the ROM, the sequence of executing jumps to the RAM to perform the patching content. After executing the patching content, the executing switches back to the ROM to execute the original executing sequence, with the present invention, the ROM chip is not necessary to be replaced when the content in the ROM needs to be corrected.

### FIELD OF THE INVENTION

The present invention generally relates to a patching method, and more particularly, to a patching method to correct the built-in code in read only memory (ROM). With an external storage device, a RAM (Random Access Memory) and a register disclosed in the present invention, the ROM chip is not necessary to be replaced when the code in the ROM needs to be corrected.

### BACKGROUND OF THE INVENTION

System-on-chip (SOC), as known as System Chip, is the major trend in electronic industry. With this most advanced technology, millions of complex electronic components used in the tradition will be integrated in a single and sophisticated chip. In general, the system embedded a SOC is called Embedded Microprocessor System in which typically a read-only memory (ROM) is incorporated to store some code (program) for controlling the system. And usually, the ROM used in such system is mask ROM. The ROM basically is made of non-volatile memory chip, the contents stored in the ROM is loaded in during the manufacturing process or burn-in after the manufacturing. Since it is read-only-memory, the content in the memory is not changeable or replaceable. When the content in such memory chip needs to be changed, the only way is to change the whole memory chip, in other words, to change or modify the mask of the memory chip, which obviously is costly.

Therefore, seeking an efficient way to improve the disadvantage is the major concern in the industry. The present invention discloses a patching method to correct the built-in code in read only memory (ROM). With an external storage device, a RAM (Random Access Memory) and a register disclosed in the present invention, the ROM chip is not necessary to be replaced when the code in the ROM is needed to be corrected, which tremendously reduce the time and cost to correct the content stored in a ROM chip.

### SUMMARY OF THE INVENTION

The primary object of the invention is to provide a patching method to correct the built-in code in read only memory (ROM). With the technology disclosed in the present invention, the ROM chip is not necessary to be replaced when the code in the ROM needs to be corrected.

To achieve the object of the present invention, the present invention disclosed a patching method to correct the built-in code in a ROM chip, which comprising the following steps: determining the existence of an external device; if the external device exists, loading a patching address stored in the external device into a register, and loading the patching content corresponding to the patching address into a random access memory; executing the codes stored in the ROM; when executing a address of code in the ROM and which is equal to the patching address in the register, executing the patching content stored in the random access memory to replace the code stored on the corresponding address in the ROM; returning back to the ROM to execute the original executing sequence after executing the patching code corresponding to the patching address.

In the method disclosed in the present invention, the way of interrupt or jump can be used to switch to execute the patching content stored in the random access memory when executing the corresponding patching address stored in the ROM. And the way of interrupt or jump can be used to return back to the ROM to execute original executing sequence after executing the patching code corresponding to the patching address.

In the present invention, the external storage device can be Electrically Erasable Programmable ROM (EEPROM), Flash Memory or had disk.

### BRIEF DESCRIPTION OF THE DRAWINGS

FIG. 1 is a schematic diagram showing an external storage and an embedded system according to the present invention.

FIG. 2 is a block diagram showing the operational flow of the present invention.

### DESCRIPTION OF THE PREFERRED EMBODIMENT

General speaking, an embedded system mainly comprises hardware of a microprocessor, ROM, RAM and input/output device, and its software (program) is stored in the ROM. With the latest chip manufacturing technology, the embedded system is possibly integrated in a SOC. However, when the content of the ROM needs to be modified or updated, traditionally, the only way is to replace the whole ROM chip. Now, with the present invention, this disadvantage can be improved efficiently.

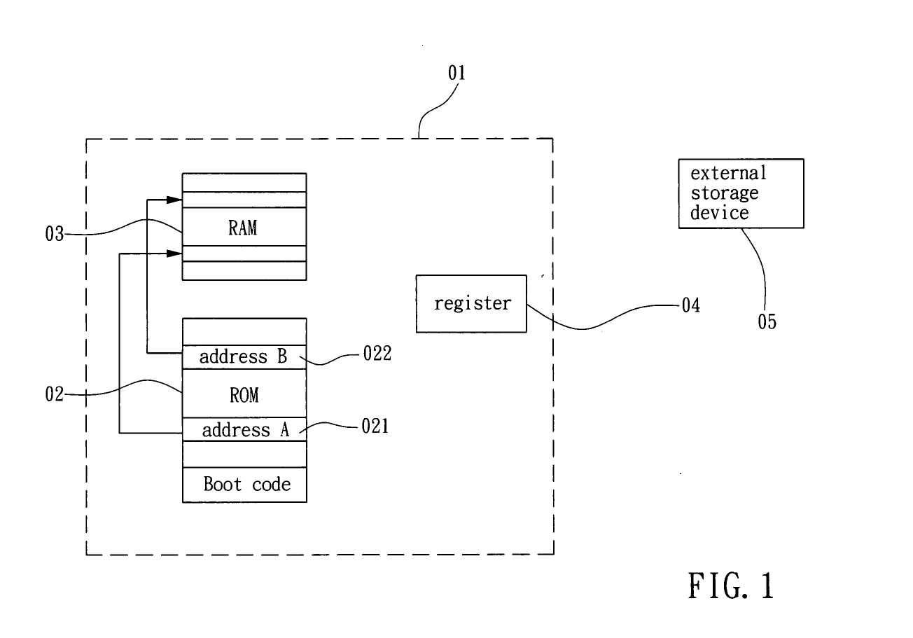

Please refer to FIG. 1, which is a schematic diagram showing an external storage and an embedded system according to the present invention. The present invention can be applied in an embodiment showing in FIG. 1 to use an external storage device to correct the built-in code in the ROM.

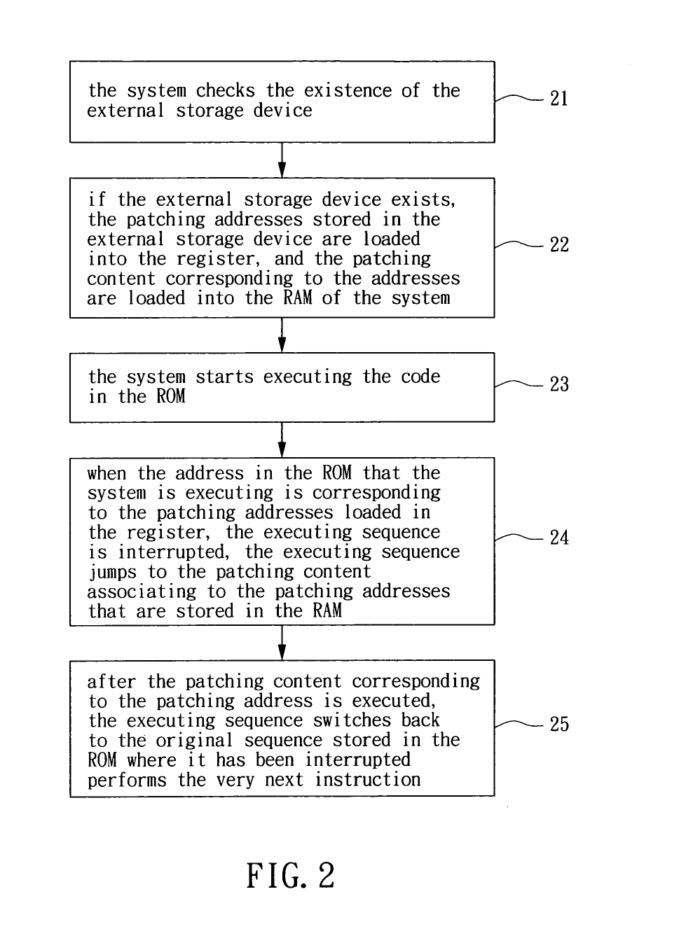

As shown in FIG. 1, the system 01 comprises a ROM 02, a RAM 03 and a register 04. The system 01 can be an embedded system and, in order to modify or update the content stored in the ROM 02, the system employs an external storage device 05 as disclosed in the present invention. In this embodiment, the code stored in the ROM needs to be modified or updated, that is, the code stored at the address A 021 and B 022 as shown in FIG. 1. Now please refer to FIG. 2, which is a block diagram showing the operational flow of the present invention. As shown in the step 21, the system checks the existence of the external storage device 05. The external storage device disclosed herein can be an Electrically Erasable Programmable ROM (EEPROM), a Flash Memory or a hard disk.

If the external storage device 05 exists, the patching address A and B stored in the external storage device 05 are loaded into the register 04 of the system, and the patching content corresponding to the address A 021 and B 022 are loaded into the RAM 03 of the system, as shown in the step 22. The address A 021 and B 022 can represent respectively the address subset of continuous address. And the way of loading the content stored in the register 05 into the register 04 or the RAM 03 can be using microprocessor, master file of hardware or Direct Memory Access (DMA).

Next, the system will start executing the code in the ROM 02, which is shown in the step 23. In general, when system boots, the codes stored in the ROM will be executed in sequence.

When the address in the ROM 02 that the system is executing is corresponding to the patching address A or B loaded in the register 04, the executing sequence is interrupted. The executing sequence will jump to the patching content associating to the patching address A or B that is stored in the RAM 03, as shown in the step 24. In one embodiment according to the present invention, a program counter and a comparator can be used to control the address which the system is executing and to compare the patching address stored in the register 04 to examine if the executing sequence is reaching the address A or B. And when the executing sequence reaches the address A or B, a method of Interrupt or Jump can be used to switch the executing sequence back to the RAM 03 to execute the patching content.

After the patching content corresponding to the patching address is executed, the executing sequence switches back to the original sequence stored in the ROM 02 where it has been interrupted and perform the very next instruction, as shown in the step 25. For example, after performing the patching content associating the address A 021 stored in the RAM 03, the way of Return or Jump can be used to perform the instruction associating the address following the address A 021 stored in the ROM 02.

In another embodiment of the present invention, a set of configuration value can be stored in the storage device 05, by which a user can determine if the patching process of the ROM needs to perform, and the set of configuration value can be read in first for future use when the existence of the storage device is detected.

In summary, the present invention provides a patching method to correct the built-in code in read only memory (ROM). As disclosed in the present invention, with an internal register and RAM incorporated a external storage device, the ROM chip is not necessary to be replaced when the code in the ROM needs to be corrected.

What is claimed is:

1. A patching method to correct the built-in code in a ROM, which comprising:
determining the existence of a external storage device;
loading a patching address stored in the external device into a register if the external storage device exists, then loading the patching content corresponding to the patching address into a random access memory; executing the codes stored in the ROM;
executing the patching content stored in the random access memory to replace the code stored on the corresponding address in the ROM when executing a address of code in the ROM that is equal to the patching address in the register;
returning back to the ROM to execute the original executing sequence after executing the patching content corresponding to the patching address.

2. The method as recited in claim 1, wherein the external storage device is an EEPROM.

3. The method as recited in claim 1, wherein the external storage device is a FLASH memory.

4. The method as recited in claim 1, wherein the external storage device is a hard disk.

5. The method as recited in claim 1, wherein the method of loading the patching content stored in the external storage device into the RAM uses a microprocessor.

6. The method as recited in claim 1, wherein the method of loading the patching content stored in the external storage device into the RAM uses a hardware MASTER.

7. The method as recited in claim 1, wherein the method of loading the patching content stored in the external storage device into the RAM uses a Direct Memory Access (DMA).

8. The method as recited in claim 1, wherein the method of switching the executing sequence from code in the ROM to the patching content in the RAM is the way of INTERRUPT.

9. The method as recited in claim 1, wherein the method of switching the executing sequence from code in the ROM to the patching content in the RAM is the way of JUMP.

10. The method as recited in claim 1, wherein the method of switching back to the original executing sequence after the patching content is executed is the way of RETURN.

11. The method as recited in claim 1, wherein the method of switching back to the original executing sequence after the patching content is executed is the way of JUMP.

12. The method as recited in claim 1, wherein the ROM is used in an embedded system.

13. The method as recited in claim 1, wherein a set of configuration values is stored in the external storage device, by which to determine if the process of patching content of the ROM is needed.
